(19) United States
(12) Patent Application Publication
(10) Pub. No.: US 2009/0090337 A1
(43) Pub. Date: Apr. 9, 2009

(54) Engine blow-by gas returning apparatus

(75) Inventors: Hiroshi Asanuma, Chita-shi (JP); Koichi Suzuki, Obu-shi (JP); Katsumi Ishida, Toyoake-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, OBU-SHI (JP)

(21) Appl. No.: 12/230,092

(22) Filed: Aug. 22, 2008

(30) Foreign Application Priority Data
Oct. 5, 2007 (JP) 2007-261800
Apr. 11, 2008 (JP) 2008-103119

(51) Int. Cl. F02B 25/06

(52) U.S. Cl. 123/574

(57) ABSTRACT

A blow-by gas returning apparatus is arranged to allow blow-by gas leaking from a combustion chamber of an engine into a crank chamber to flow in an intake passage through a returning passage, and to regulate a flow rate of the blow-by gas by a PCV valve placed in the returning passage. A supercharger is placed in the intake passage. The PCV valve is adapted to change a position of the valve element by electromagnetic force to change a passage opening area. A check valve is placed integral with the PCV valve in the returning passage between the valve element of the PCV valve and the intake passage. The check valve is arranged to inhibit back-flow of the gas from the intake passage.

### BACKGROUND OF THE INVENTION

1. Field of the Invention

The present invention relates to an engine blow-by gas returning apparatus arranged to cause blow-by gas leaking from a combustion chamber of an engine into a crank case to flow in an intake system of the engine and then return to the combustion chamber.

2. Description of Related Art

Heretofore, there have been known some techniques of this type disclosed in JP8 (1996)-338222A, JP56 (1981)-129556U, JP2003-184532A, and JP62 (1987)-150514U. In particular, JP '222A discloses that a flow rate of blow-by gas in a returning passage is regulated by an electromagnetically driven PCV valve.

On the other hand, JP '556U discloses a blow-by gas processing apparatus provided for an engine with a supercharger and provided with a first returning passage for allowing blow-by gas to flow from an engine body to an intake passage upstream of the supercharger and a second returning passage for allowing blow-by gas to flow from the engine body to the intake passage downstream of the supercharger, and a check valve placed in each returning passage to interrupt a back-flow of the gas from the intake passage.

JP '532A discloses a crankcase ventilation system provided for an engine with a supercharger and provided with a first returning passage for allowing blow-by gas to flow from an engine body to an intake passage upstream of the supercharger, a second returning passage for allowing blow-by gas to flow from the engine body to the intake passage downstream of the supercharger, and a check valve placed in each returning passage to interrupt a back-flow of the gas from the intake passage, in which negative pressure levels in the returning passages can be controlled by a single control device.

Furthermore, JP '514U discloses a blow-by gas returning apparatus provided for an engine with a supercharger and provided with a first returning passage for allowing blow-by gas to flow from an engine body to an intake passage upstream of the supercharger, a second returning passage for allowing blow-by gas to flow from the engine body to the intake passage downstream of the supercharger, a PCV valve in the second returning passage, and an on-off valve arranged to close the second returning passage when the PCV valve is opened.

In the case where the technique disclosed in JP '222A is applied to an engine with a supercharger as mentioned in JP '556U, JP '532A, and JP '514U, there is a risk that high-pressure gas flows back in the returning passage to flow in the PCV valve when the pressure in the intake passage suddenly rises due to supercharged air by the supercharger or backfire. Herein, the PCV valve is an electromagnetically driven valve, which will not be closed by action of the high-pressure gas flowing back therein. Accordingly, the back-flow of the high-pressure gas in the PCV valve may cause damage to a valve element of the PCV valve and the crank case.

### BRIEF SUMMARY OF THE INVENTION

The present invention has been made in view of the above circumstances and has an object to provide an engine blow-by gas returning apparatus capable of protecting a PCV valve or a crank case from excessive pressure rise even when the pressure in an intake passage suddenly rises and acts on a returning passage.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the above object, according to one aspect, the invention provides an engine blow-by gas returning apparatus comprising: a returning passage through which blow-by gas which leaks from a combustion chamber of an engine into a crank case is allowed to flow in an intake passage to return to the combustion chamber; and a PCV valve placed in the returning passage to regulate a flow rate of the blow-by gas, wherein the PCV valve is adapted to change a position of a valve element by electromagnetic force to change a passage opening area, and the apparatus further includes an inhibition valve for inhibiting back-flow of gas from the intake passage, the inhibition valve being placed in the returning passage upstream of the valve element of the PCV valve.

According to another aspect, the invention provides an engine blow-by gas returning apparatus comprising: a returning passage through which blow-by gas which leaks from a combustion chamber of an engine into a crank case is allowed to flow in an intake passage to return to the combustion chamber; and a PCV valve placed in the returning passage to regulate a flow rate of the blow-by gas, wherein the PCV valve is adapted to change a position of a valve element by electromagnetic force to change a passage opening area, and the apparatus further includes an inhibition valve for inhibiting back-flow of gas from the intake passage, the inhibition valve being placed in the returning passage downstream of the valve element of the PCV valve.

Furthermore, according to another aspect, the invention provides an engine blow-by gas returning apparatus comprising: a returning passage through which blow-by gas which leaks from a combustion chamber of an engine into a crank case is allowed to flow in an intake passage, in which a supercharger is placed, to return to the combustion chamber; and a PCV valve placed in the returning passage to regulate a flow rate of the blow-by gas, wherein the PCV valve is adapted to change a position of a PCV valve element by pressure to change a passage opening area, the returning passage has one end communicatable with inside of the crank case and the other end communicating with the intake passage downstream of the supercharger, the apparatus further comprises an inhibition valve placed in the returning passage and adapted to inhibit a flow of gas from the intake passage, a second returning passage having one end communicating with the returning passage upstream of the inhibition valve and the other end communicatable with the intake passage upstream of the supercharger, and a second PCV valve placed in the second returning passage and adapted to change a position of the valve element by pressure to change a passage opening area, the second PCV valve is operated to increase the passage opening area as a difference in pressure between an upstream side and a downstream side of the second PCV valve is larger.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a schematic configuration view showing a gasoline engine system including a blow-by gas returning apparatus in a first embodiment;

FIG. 2 is a sectional view of a PCV valve in the first embodiment;

FIG. 3 is a sectional view of a PCV valve in a second embodiment;

FIG. 4 is a schematic configuration view showing a gasoline engine system including a blow-by gas returning apparatus in a third embodiment;

FIG. 5 is a sectional view of a PCV valve in the third embodiment;

FIG. 6 is a sectional view of a multiple-PCV valve in a fourth embodiment;

FIG. 7 is a sectional view of a check valve in a fifth embodiment;

FIG. 8 is another sectional view of the check valve in the fifth embodiment;

FIG. 9 is a sectional view of a PCV valve in a sixth embodiment;

FIG. 10 is another sectional view of the PCV valve in the sixth embodiment; and

FIG. 11 is another sectional view of the PCV valve in the sixth embodiment.

### DETAILED DESCRIPTION OF THE PREFERRED EMBODIMENTS

### First Embodiment

A detailed description of a first preferred embodiment of an engine blow-by gas returning apparatus embodying the present invention will now be given referring to the accompanying drawings.

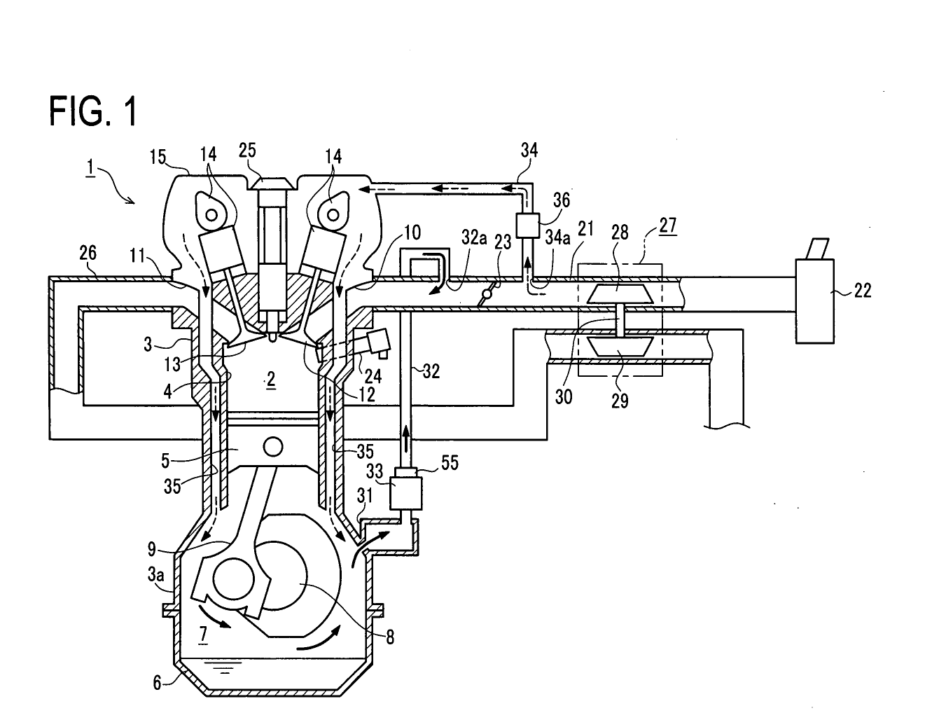

FIG. 1 is a schematic configuration view of a gasoline engine system including a blow-by gas returning apparatus in this embodiment. An engine 1 constituting this engine system is a multiple-cylinder ignition engine of a direct injection type arranged to directly inject fuel into a combustion chamber 2. An engine block 3 constituting the engine 1 is formed with a plurality of cylinder bores 4 in each of which a piston 5 is provided to be vertically movable. A lower part of the engine block 3 is provided with a crank case 3a, which is assembled with an oil pan 6. Those crank case 3a and oil pan 6 form a crank chamber 7. In this crank chamber 7, a crank shaft 8 is rotatably supported and coupled to each piston 5 through each connecting rod 9.

The combustion chamber 2 formed above the piston 5 in each cylinder bore 4 has a pent roof shape slant to be highest at its upper center. In each combustion chamber 2, the engine block 3 is formed at an upper part thereof with an intake port 10 and an exhaust port 11. An intake valve 12 is set in the intake port 10 while an exhaust valve 13 is set in the exhaust port 11. The intake valve 12 and the exhaust valve 13 are opened and closed in association with rotation of the crank shaft 8 by a well known valve operating mechanism 14. By opening and closing of the intake valve 12 and the exhaust valve 13, outside air is introduced in the combustion chamber 2 through the intake port 10 and exhaust gas resulting from combustion is discharged from the combustion chamber 2 through the exhaust port 11. An engine cover 15 is provided on the engine block 3 to cover the valve operating mechanism 14 and others.

The intake port 10 is connected to an intake passage 21 including an intake manifold, an intake pipe, and others. An entrance of this intake passage 21 is connected to an air cleaner 22. A throttle valve 23 is mounted in a predetermined portion of the intake passage 21. The throttle valve 23 is opened and closed in synchronization with operation of an accelerator pedal (not shown) mounted on a driver's side floor. The air purified by the air cleaner 22 is sucked in the combustion chamber 2 via the intake passage 21 and the intake port 10. An amount of this sucked air is regulated by an opening degree of the throttle valve 23. To the engine block 3, injectors 24 are attached to directly inject fuel into corresponding combustion chambers 2. The fuel injected from the injector 24 into the combustion chamber 2 is mixed with the air sucked in the combustion chamber 2 through the intake port 10, forming an air-fuel mixture. An ignition plug 25 is also provided at the top of the engine block 3 to ignite the air-fuel mixture in each combustion chamber 2.

The exhaust port 11 is connected with an exhaust passage 26 including the exhaust manifold, an exhaust pipe, and others. The exhaust gas resulting from combustion of the air-fuel mixture in each combustion chamber 2 is exhausted to the outside through the exhaust port 11 and the exhaust passage 26.

In this embodiment, a supercharger 27 is placed in the intake passage 21 and the exhaust passage 26 to pressurize intake air in the intake passage 21. The supercharger 27 includes a compressor 28 placed in the intake passage 21, a turbine 29 placed in the exhaust passage 26, and a rotation shaft 30 connected at both ends with the compressor 28 and the turbine 29 for integrally rotating them. This supercharger 27 is configured such that the turbine 29 is rotated by exhaust gas flowing in the exhaust passage 26 and the compressor 28 is rotated together through the rotation shaft 30, thereby pressurizing, or supercharging, the intake air in the intake passage 21.

The aforementioned engine 1 is provided with a blow-by gas returning apparatus for allowing blow-by gas leaking from each combustion chamber 2 into the inside of the crank case 3a (the crank chamber 7) to flow in the intake passage 21 to return to each combustion chamber 2. Specifically, the crank case 3a includes an oil separator 31 communicating with the crank chamber 7. This oil separator 31 exhibits the function of separating oil content such as lubricant mixed in the blow-by gas in the crank chamber 7 from the blow-by gas and trapping the separated oil content. Between the oil separator 31 and the intake passage 21 downstream of the throttle valve 23, a returning passage 32 constituted of a returning pipe and others is arranged to allow the blow-by gas to flow from the crank chamber 7 to the intake passage 21. In a predetermined portion of the returning passage 32, a PCV valve 33 is mounted for regulating a flow rate of the blowby gas. The detailed configuration of the PCV valve 33 will be mentioned later. Between the intake passage 21 and the engine cover 15, a scavenging passage 34 is arranged to introduce intake air as fresh air into the crank chamber 7 in order to scavenge the blowby gas from the crank chamber 7. The scavenging passage 34 is placed with its entrance 34a opening in the intake passage 21 upstream of the throttle valve 23 but downstream of the compressor 28 of the supercharger 27. The engine block 3 is formed with vent holes 35 for providing communication between the crank chamber 7 and the inside of the engine cover 15. Through each vent hole 35, the fresh air introduced in the engine cover 15 is allowed to flow in the crank chamber 7. Each vent hole 35 also constitutes part of the scavenging passage 34. A pressure control valve 36 is placed in a predetermined portion of the scavenging passage 34. This pressure control valve 36 is configured to close the scavenging passage 34 when high charging pressure is exerted on the scavenging passage 34 by the supercharger 27.

An opening 32a of the returning passage 32 opening in the intake passage 21 is placed downstream of the throttle valve 23. Because of this placement, intake negative pressure generated downstream of the throttle valve 23 will act in the returning passage 32 through the opening 32a. The compressor 28 of the supercharger 27 is placed in the intake passage 21 upstream of the opening 32a of the returning passage 32 and the throttle valve 23.

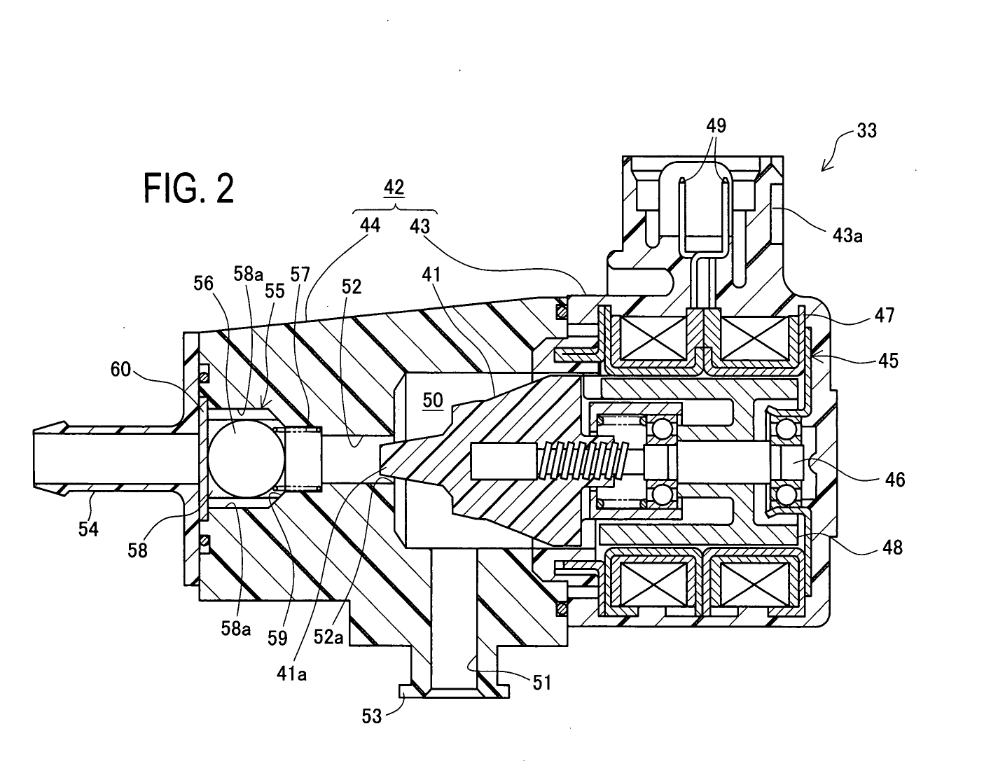

Herein, the details of the PCV valve 33 is explained. FIG. 2 is a sectional view of the PCV valve 33. As shown in FIG. 2, the PCV valve 33 is configured to change the position of a valve element 41 by electromagnetic force, thereby changing a passage opening area defined by the valve element 41. The PCV valve 33 includes a hollow housing 42 made of resin. The housing 42 is constituted of a main housing 43 and a sub housing 44 assembled together.

The main housing 43 includes a connector part 43a formed on the top and a step motor 45 internally integrally contained. An output shaft 46 of the step motor 45 is connected with the valve element 41. The step motor 45 includes a stator 47 which generates an electromagnetic force and a rotor 48 centrally placed in the stator 47 and integrally combined with the output shaft 46. The output shaft 46 and the valve element 41 are joined with respective screw threads and grooves. Leading ends of external terminals 49 extending from the stator 47 protrude in the connector part 43a.

The sub housing 44 is formed with a valve chamber 50 housing the valve element 41 and two ports 51 and 52 communicating with the valve chamber 50. In the valve chamber 50, the valve element 41 is arranged to be axially slidable but held against rotation. One inlet port 51 communicates with the oil separator 31 to admit the blow-by gas from the crank chamber 7. The other outlet port 52 communicates with the returning passage 32 to deliver the blow-by gas thereto. Accordingly, the sub housing 44 with the inlet port 51, the valve chamber 50, and the outlet port 52, forming a blow-by gas passage, constitutes part of the returning passage of the present embodiment. The sub housing 44 is formed with pipe joints 53 and 54 in correspondence with the inlet port 51 and the outlet port 52 respectively. The outlet port 52 is formed coaxial with the central axis of the valve element 41 and has an opening 52a at one end in which a distal end 41a of the valve element 41 can move ahead. The distal end 41a of the valve element 41 is formed in a tapered shape. As the distal end 41a moves ahead into the outlet port 52, a passage opening area (an opening degree) between the opening 52a of the outlet port 52 and the distal end 41a of the valve element 41 becomes smaller. As the output shaft 46 of the step motor 45 rotates normally and the valve element 41 moves into the outlet port 52, the opening degree between the outlet port 52 and the valve element 41 becomes smaller. As the output shaft 46 of the step motor 45 rotates reversely and the valve element 41 moves away from the outlet port 52, the opening degree between the outlet port 52 and the valve element 41 becomes larger.

In the sub housing 44, a ball check valve 55 for inhibiting back-flow of gas from the intake passage 21 is placed in a predetermined place in the outlet port 52, that is, in the returning passage 32 between the valve element 41 of the PCV valve 33 and the intake passage 21. This check valve 55 includes a ball 56 and a spring 57 which are housed in a valve chamber 58 formed in the predetermined place in the outlet port 52. An inner wall of the valve chamber 58 is formed with a valve seat 59 for receiving the ball 56. When high pressure gas from the intake passage 21 acts on the outlet port 52, causing the ball 56 to come into contact with the valve seat 59 against the urging force of the spring 57, the check valve 55 is closed to inhibit back-flow of high pressure gas from the intake passage 21. A partition plate 60 is placed on an exit side of the valve chamber 58. This partition plate 60 has a plurality of through holes extending in a thickness direction, not shown in FIG. 2, through which gas passes. The inner wall of the valve chamber 58 is formed with a plurality of grooves 58a extending in a longitudinal direction, through which gas passes.

According to the blow-by gas returning apparatus in this embodiment described above, when the pressure in the intake passage 21 suddenly increases by backfire from the combustion chamber 2, the check valve 55 provided in the outlet port 52 of the PCV valve 33 is operated to inhibit the back-flow of high pressure gas from the intake passage 21 into the PCV valve 33. When the intake pressure suddenly increases by charging pressure by operation of the supercharger 27, the check valve 55 is also operated to inhibit the back-flow of high pressure gas from the intake passage 21 into the PCV valve 33. Accordingly, the PCV valve 33, and the crank case 3a and the oil pan 6 both located upstream of the PCV valve 33, can be protected from excessive pressure rise. In this embodiment, particularly, the valve element 41 and the step motor 45 constituting the PCV valve 33 will not receive any backfire pressure and hence those components 41 and 45 do not have to be so solidly constructed as to sufficiently resist the backfire pressure. Thus, weight reduction and cost reduction of the PCV valve 33 can be achieved. Furthermore, the crank chamber 7 will not receive any charging pressure and accordingly oil content will not be taken away from the crank chamber 7 through the scavenging passage 34. Oil consumption can therefore be restrained.

In this embodiment, the entrance 34a of the scavenging passage 34 communicates with the intake passage 21 downstream of the supercharger 27. Accordingly, the intake air flowing in the intake passage 21 downstream of the supercharger 27 is introduced as fresh air into the crank chamber 7 through the entrance 34a and the scavenging passage 34. This fresh air can efficiently scavenge the crank chamber 7. In case high charging pressure caused by the supercharger 27 acts on the scavenging passage 34, this scavenging passage 34 is closed by the pressure control valve 36 and hence excessive charging pressure will not act on the crank chamber 7 through the scavenging passage 34. In this regard, similarly, the crank case 3a and the oil pan 6 can be protected from excessive pressure rise.

### Second Embodiment

A second embodiment of an engine blow-by gas returning apparatus according to the present invention will be described referring to the accompanying drawing.

In each subsequent embodiment, the same or similar components as those in the first embodiment are given the same reference signs and their details are not omitted. The following explanation will be made with a focus on differences from the first embodiment.

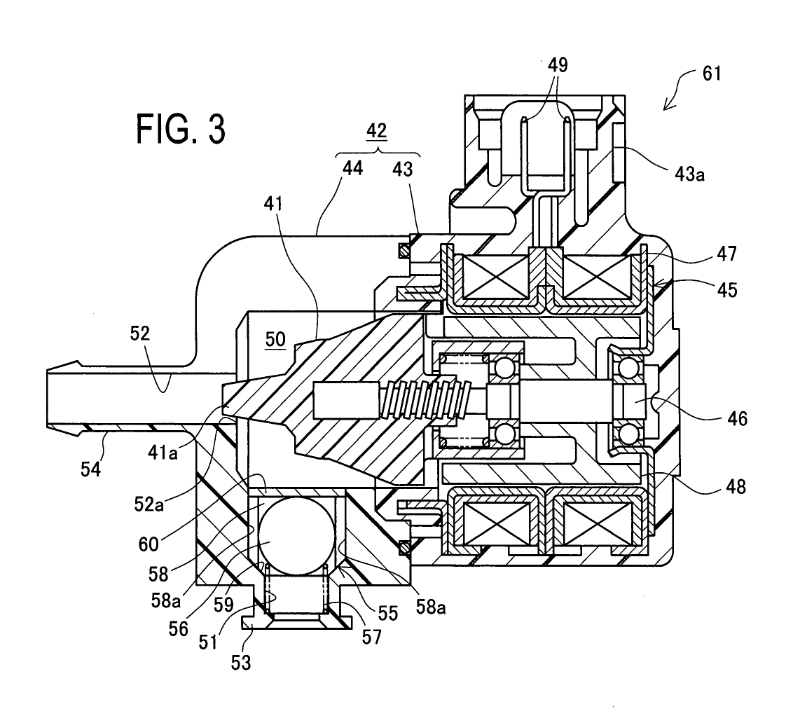

FIG. 3 is a sectional view of a PCV valve 61 in the second embodiment. The blow-by gas returning apparatus in this embodiment differs from the first embodiment in a configuration of the PCV valve 61. Specifically, this PCV valve 61 differs from that in the first embodiment in the shape of the sub housing 44 and the placement of the check valve 55. The sub housing 44 is formed to be axially shorter than that in the first embodiment. In the second embodiment, the check valve 55 is placed in the inlet port 51. This check valve 55 is identical in structure to that in the first embodiment. When high pressure gas from the intake passage 21 acts on the outlet port 52 and the valve chamber 50 of the PCV valve 61 through the returning passage 32, causing the ball 56 to come into contact with the valve seat 59 against the urging force of the spring 57, the check valve 55 is closed to inhibit back-flow of high pressure gas from the intake passage 21.

In this embodiment, similarly, when the pressure in the intake passage 21 suddenly increases by backfire or when the intake pressure suddenly increases due to the charging pressure by the supercharger 27, the check valve 55 provided in the inlet port 51 of the PCV valve 61 is operated to inhibit the back-flow of high pressure gas from the intake passage 21 into the crank chamber 7. Accordingly, the crank case 3a and the oil pan 6 can be protected from excessive pressure rise. In this embodiment, unlike the first embodiment, the high pressure gas will flow in the valve chamber 50 of the PCV valve 61. However, the valve element 41, the step motor 45, and other components are configured so solidly as to ensure durability to high pressure. In this embodiment, similarly, the crank chamber 7 will not receive any charging pressure and accordingly oil content will not be taken away from the crank chamber 7 through the scavenging passage 34. Oil consumption can therefore be restrained. Other operations and advantages in this embodiment are the same as those in the first embodiment.

### Third Embodiment

A third embodiment of an engine blow-by gas returning apparatus according to the present invention will be described referring to the accompanying drawing.

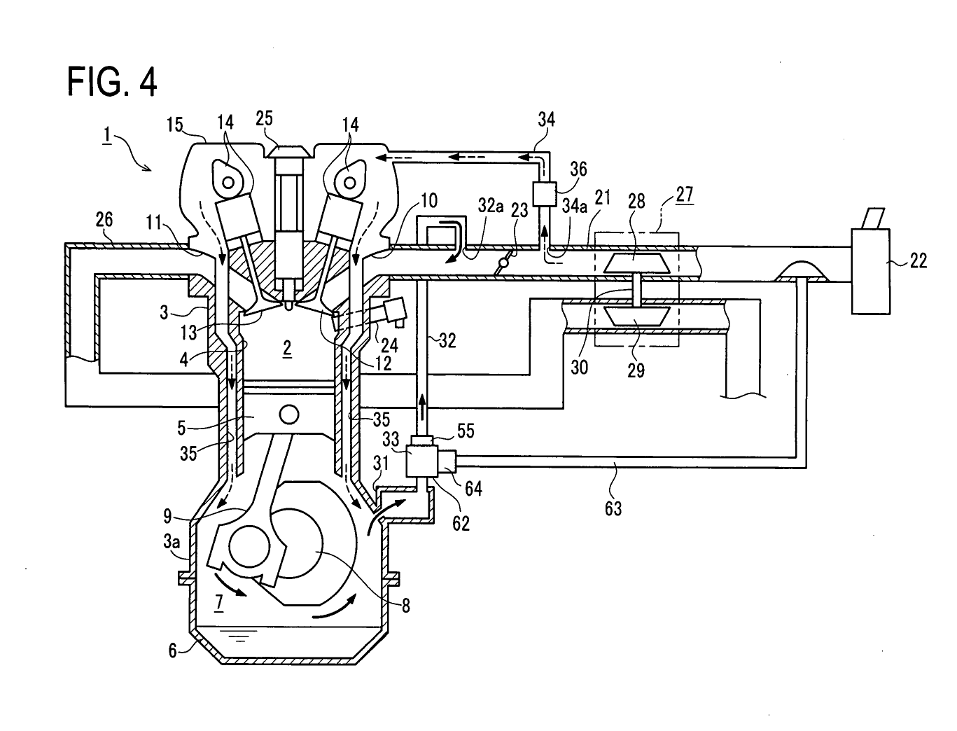

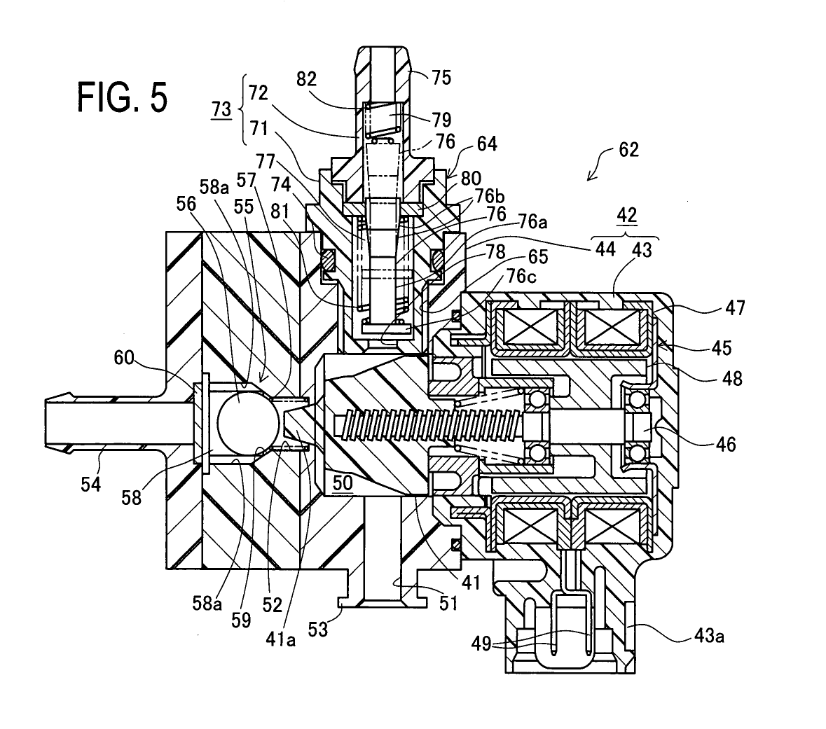

FIG. 4 is a schematic configuration view of a gasoline engine system including a blow-by gas returning apparatus in the third embodiment. FIG. 5 is a sectional view of a first PCV valve 62 in the third embodiment. This embodiment differs from the aforementioned embodiments in a passage configuration of the blow-by gas returning apparatus, a configuration of the first PCV valve 62, and others. Specifically, as shown in FIG. 4, the blow-by gas returning apparatus is further provided with a second returning passage 63 and the second PCV valve 64. The second PCV valve 64 is provided integral with the first PCV valve 62. The second returning passage 63 is disposed so that one end connected with the second PCV valve 64 and the other end communicating with the intake passage 21 upstream of the supercharger 27. As shown in FIG. 5, the first PCV valve 62 differs from that in the first embodiment in a configuration of the sub housing 44. The sub housing 44 is made of a plurality of blocks assembled together. In the sub housing 44, the check valve 55 is provided in a predetermined position of the outlet port 52. The sub housing 44 is further formed with a screw-thread portion 65 communicating with the valve chamber 50. The second PCV valve 64 is threadedly engaged in this screw-thread portion 65.

The second PCV valve 64 includes a hollow housing 73 constituted of two housing members 71 and 72. A first housing member 71 is threaded and fixed in the screw-thread portion 65 of the PCV valve 62 with a seal ring 74 being fitted on an outer periphery of the housing member 71. The second housing member 72 is fixed to the first housing member 71 in such a manner that the outer periphery of a proximal end of the second housing member 72 is welded to an open distal end of the first housing member 71 by ultrasonic welding. A distal end of the second housing member 72 forms a pipe joint 75. This pipe joint 75 is connected to one end of a pipe constituting the second returning passage 63. A hollow part of the first housing member 71 forms a valve chamber 77 housing a valve element 76. At one end of the valve element 77, the first housing member 71 is formed with an entrance opening 78 communicating with the valve chamber 50 of the first PCV valve 62. The valve chamber 77 of the first housing member 71 communicates with a hollow part 79 of the second housing member 72. An annular valve seat 80 is placed between the first and second housing members 71 and 72. The valve element 76 placed in the valve chamber 77 is disposed so as to extend through the valve seat 80. The valve element 76 includes a columnar proximal end portion 76a (a lower part in the figure) and a two-stage tapered distal end portion 76b (an upper part in the figure). The distal end portion 76b is made larger and larger in diameter toward the distal end. Thus, as the valve element 76 is moved toward the valve seat 80, a passage opening area (an opening degree) between the valve seat 80 and the valve element 76 is changed to become gradually larger. The valve element 76 is provided with a flange 76c at the end of the proximal end portion 76a. A compression spring 81 is mounted between the valve seat 80 and the flange 76c. This spring 81 urges the valve element 76 toward the entrance opening 78, that is, in a direction that decreases the passage opening area (in a valve closing direction). The distal end portion 76b of the valve element 76 extends through the valve seat 80 so as to move in the hollow part 79 of the second housing member 72. In the hollow part 79 of the second housing member 72, another compression spring 82 is mounted for restricting the movement of the valve element 76. The valve chamber 77 and the hollow part 79 of the second PCV valve 64 mentioned above constitute part of the second returning passage 63.

When the check valve 55 is closed, accordingly, the blow-by gas flowing in the valve chamber 50 through the inlet port 51 of the first PCV valve 62 enters the valve chamber 77 through the entrance opening 78 of the second PCV valve 64, and the pressure of the gas acts on the proximal end portion 76a of the valve element 76. Furthermore, atmospheric pressure acts on the distal end portion 76b of the valve element 76 through the intake passage 21 and the second returning passage 63. Based on the pressures acting on the proximal end portion 76a and the distal end portion 76b of the valve element 76 and a difference from the urging force of the spring 81, i.e. a pressure difference, the valve element 76 is moved in its axial direction, changing the passage opening area (the opening degree) between the valve seat 80 and the valve element 76. Thus, the flow rate of blow-by gas allowed to flow from the valve chamber 77 into the hollow part 79, that is, to be measured by the second PCV valve 64 is regulated. The second PCV valve 64 is adapted to change the passage opening area (the opening degree) between the valve element 76 and the valve seat 80 by changing the position of the valve element 76 by action of the pressure of blow-by gas.

According to the blow-by gas returning apparatus in this embodiment, while the check valve 55 of the first PCV valve 62 is operated to close the outlet port 52, the pressure of blow-by gas in the crank chamber 7 flows in the valve chamber 50 through the inlet port 51 of the first PCV valve 62 and then the gas flows in the valve chamber 77 through the entrance opening 78 of the second PCV valve 64. At that time, based on a difference in pressure between an upstream side and a downstream side of the second PCV valve 64, the valve element 76 is moved and hence the passage opening area (the opening degree) increases, thereby causing the blow-by gas in the crank chamber 7 to flow in the intake passage 21 upstream of the supercharger 27 through the second returning passage 63. Even if the check valve 55 is closed by charging pressure to interrupt the flow of blow-by gas to the returning passage 32, the blow-by gas is allowed to flow in the intake passage 21 through the second returning passage 63. Accordingly, the crank case 3a, the oil pan 6, and the first PCV valve 62 can be protected from excessive pressure rise of blow-by gas.

In this embodiment, additionally, the second PCV valve 64 is adapted to increase the passage opening area (the opening degree) as the difference in pressure becomes larger between the upstream side and the downstream side of the second PCV valve 64. Accordingly, as the pressure of blow-by gas in the crank chamber 7 increases, the difference in pressure becomes larger between the upstream side and the downstream side of the second PCV valve 64, thus increasing the passage opening area (the opening degree) of the second PCV valve 64 to allow more blow-by gas to flow in the intake passage 21 through the second returning passage 63. The blow-by gas is therefore allowed to efficiently flow in the intake passage 21 according to the level of pressure rise in the crank chamber 7.

### Fourth Embodiment

A fourth embodiment of an engine blow-by gas returning apparatus according to the present invention will be described referring to the accompanying drawing.

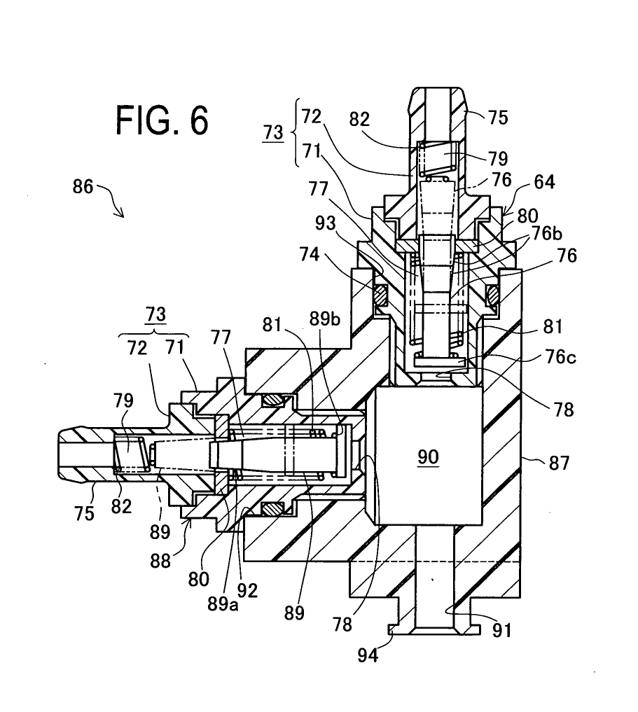

FIG. 6 is a sectional view of a multiple PCV valve 86 in the fourth embodiment. This embodiment differs from the third embodiment in configurations of the first and second PCV valves. Specifically, as shown in FIG. 6, the multiple PCV valve 86 includes a first PCV valve 88 and the second PCV valve 64 which are integrally provided in a valve block 87. The second PCV valve 64 is identical to that in the third embodiment. The first PCV valve 88 is arranged to change the position of a valve element 89 by pressure, instead of the electromagnetic force in the first to third embodiments in which the position of the valve element 41 is changed by the step motor 45. The valve block 87 is provided with an internal hollow part 90, an inlet port 91 communicating with the hollow part 90, and first and second mounting holes 92 and 93 communicating with the hollow part 90. The first PCV valve 88 is mounted in the first mounting hole 92 and the second PCV valve 64 is mounted in the second mounting hole 93. The configuration of the first PCV valve 88 is similar to the second PCV valve 64 excepting the shape of the valve element 89. The valve element 89 of the first PCV valve 88 includes a distal end portion 89a of a tapered shape gradually decreasing in diameter toward a distal end. A compression spring 81 is mounted between a flange 89b formed at a proximal end of the valve element 89 and the valve seat 80. Accordingly, as the valve element 89 is moved toward the valve seat 80, a passage opening area (an opening degree) between the valve seat 80 and the valve element 89 is changed to become gradually smaller. The pipe joint 75 of the first PCV valve 88 is connected with a pipe constituting the returning passage 32. The pipe joint 75 of the second PCV valve 64 is connected with a pipe constituting the second returning passage 63. A pipe joint 94 formed at the inlet port 91 is connected with the oil separator 31.

While the engine 1 is running and the supercharger 27 does not operate, the first PCV valve 88 will operate as follows. Specifically, intake negative pressure acts on the valve chamber 77 of the first PCV valve 88 through the intake passage 21 and the returning passage 32. Furthermore, the blow-by gas highly charged in the crank chamber 7 of the engine 1 enters the valve chamber 77 through the inlet port 91 and the hollow part 90 of the valve block 87 and then the entrance opening 78 of the first PCV valve 88. The pressure of that gas acts on the valve element 89. At that time, the intake negative pressure acts on the valve element 89 against the urging force of the spring 81 and the pressure of the gas acts on the valve element 89, thereby moving the valve element 89 toward the valve seat 80. This changes the passage opening area (the opening degree) between the valve seat 80 and the valve element 89. Thus, a flow rate of blow-by gas allowed to flow from the valve chamber 77 into the hollow part 79, i.e., to be measured by the first PCV valve 88 is regulated. While the supercharger 27 operates, charging pressure acts on the valve chamber 77 of the first PCV valve 88, thereby pressing the valve element 89 to close the entrance opening 78 by the flange 89b. This interrupts the back-flow of high pressure gas from the first PCV valve 88 to the hollow part 90. In other words, the first PCV valve 88 in this state exhibits the same function as the check valve 55 in each of the aforementioned embodiments. At that time, the second PCV valve 64 acts as in the third embodiment, allowing the blow-by gas flowing from the crank chamber 7 into the hollow part 90 of the valve block 87 to flow into the intake passage 21 upstream of the supercharger 27 through the second PCV valve 64 and the second returning passage 63.

The blow-by gas returning apparatus in this embodiment can provide basically the same operations and advantages as in the third embodiment. In the fourth embodiment, additionally, the first PCV valve 88 is simply configured to change the position of the valve element 89 by pressure and correspondingly a simpler structure of the apparatus can be achieved.

### Fifth Embodiment

A fifth embodiment of an engine blow-by gas returning apparatus according to the present invention will be described referring to the accompanying drawings.

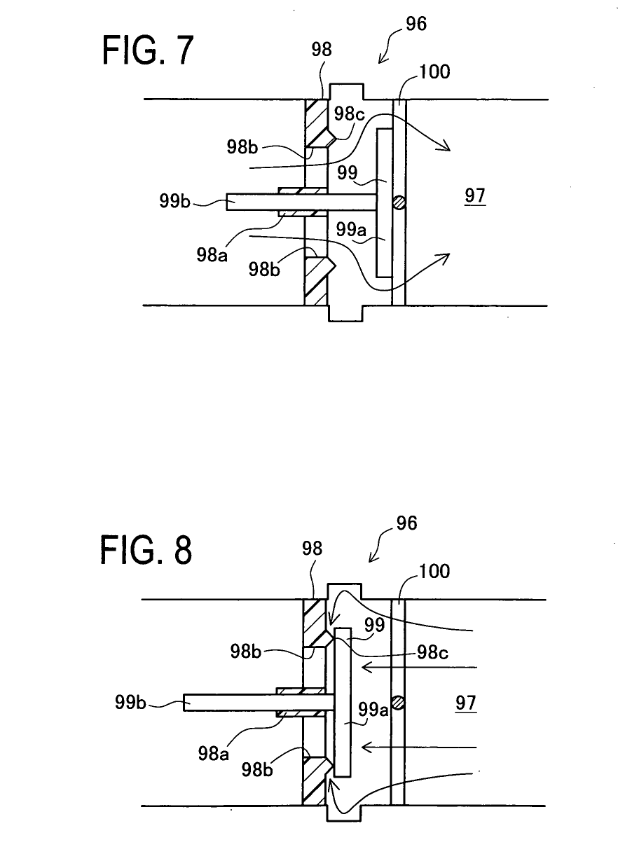

FIGS. 7 and 8 are schematic sectional views of a check valve 96 in the fifth embodiment. This embodiment differs from the first to third embodiments in the use of a plate-type check valve 96 is provided instead of the ball-type check valve. As shown in FIGS. 7 and 8, the check valve 96 in this embodiment includes a plate-like base 98 fixedly placed in a passage 97, a plate-like valve element 99 supported to be axially movable relative to the base 98, and a stopper 100 fixed in the passage 97 downstream of the base 98 to restrict movement of the valve element 99. The base 98 is provided with a centrally formed boss 98a, a plurality of vent holes 98b arranged around the boss 98a, and a circumferential rib 98c protruding from a downstream-side surface of the base 98 to surround the vent holes 98b. The valve element 99 includes a plate-like body 99a and a support rod 99b extending from the body 99a. The valve element 99 is supported to be slidable relative to the boss 98a by the support rod 99b. The stopper 100 is formed for example in a cross frame shape in plan view to permit passage of gas through clearances between frames.

According to the check valve 96 in this embodiment, when blow-by gas flows in a normal direction in the passage 97 as shown in FIG. 7, the pressure of the blow-by gas passing through the vent holes 98b of the base 98 presses the valve element 99 into contact with the stopper 100. At that time, the blow-by gas passing through the vent holes 98b flows downstream by passing through between the rib 98c and the valve element 99 and between the valve element 99 and the stopper 100. When high pressure gas attempts to flow back in the passage 97 as shown in FIG. 8, on the other hand, the high pressure gas presses the valve element 96 into contact with the rib 98c. In this state, the clearance between the rib 98c and the valve element 99 is sealed, interrupting the passage of high pressure gas, and thereby preventing the back-flow of high pressure gas in the passage 97.

### Sixth Embodiment

A sixth embodiment of an engine blow-by gas returning apparatus according to the present invention will be described referring to the accompanying drawings.

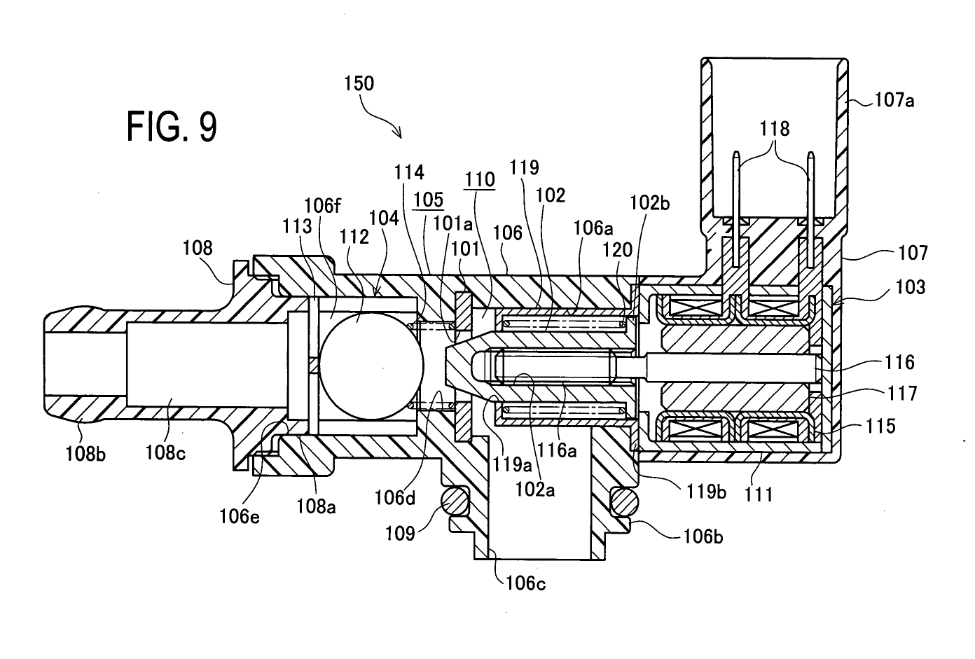

FIGS. 9 to 11 are sectional views of a PCV valve 150 in the sixth embodiment. In this embodiment, the PCV valve 150 differs from the PCV valve 33 in the first embodiment in a positional relation between a valve element 102 and a ball 112 of a check valve 104.

In this embodiment, similarly, the PCV valve 150 is arranged to change a passage opening area by the valve element 102 based on the changeable position of the valve element 102 by electromagnetic force. Specifically, as shown in FIG. 9, the PCV valve 150 is schematically provided with a valve seat 101, the valve element 102, a step motor 103 for moving the valve element 102 by electromagnetic force, the ball check valve 104 for inhibiting back-flow of gas from the intake passage 21, and a housing 105 in which the valve seat 101, the valve element 102, the step motor 103, and the check valve 104 are housed. This PCV valve 150 is configured such that the step motor 103 is activated by energization to change the position of the valve element 102 relative to the valve seat 101, thereby changing the dimension of the blow-by gas passage between the valve seat 101 and the valve element 102, that is, the passage opening area for blow-by gas, to regulate the flow rate of blow-by gas to be measured by the PCV valve 150.

In this embodiment, the housing 105 is of a hollow shape, constituted of three separate parts; a first housing 106, a second housing 107, and a third housing 108. These first to third housings 106 to 108 are made of resin respectively. The first housing 106 includes an internal hollow part 106a and an inlet-side pipe joint 106b formed under the hollow part 106a. The inlet-side pipe joint 106b includes an inlet port 106c communicating with the hollow part 106a and is attached with a seal ring 109 on an outer periphery. Major part of the hollow part 106a forms a valve chamber 110 in which the valve element 102 is placed. At an outlet side of the valve chamber 110, an outlet port 106d is formed, in which the valve seat 101 is placed.

The second housing 107 integrally houses the step motor 103 by insert-molding and is formed with a connector part 107a above the housing 107. The step motor 103 is covered by a metallic motor case 111. The third housing 108 is connected with the first housing 106 in such a way that a proximal-end periphery portion 108a is press-fitted into a distal end opening 106e of the first housing 106 and fixed thereto by ultrasonic welding. The third housing 108 includes an outlet-side pipe joint 108b at its distal end and a hollow part 108c therein. The inlet-side pipe joint 106b of the first housing 106 is connected with the oil separator 31 to receive the blow-by gas from the crank chamber 7 through the inlet port 106c. The outlet-side pipe joint 108b of the third housing 108 is connected with one end of the returning passage 32 communicating with the intake passage 21 of the engine. In this embodiment, the inlet port 106c of the first housing 106, the valve chamber 110 and the outlet port 106d, and the hollow part 108c of the third housing 108 constitute the blow-by gas passage through which the blow-by gas passes.

In this embodiment, in the first housing 106, the check valve 104 is placed between the outlet port 106d and the distal end opening 106e. This check valve 104 includes the ball 112, a retainer plate 113 for retaining the ball 112, and a spring 114 that urges the ball 112 in a valve opening direction. The ball 112 and the retainer plate 113 are housed in a valve chamber 106f formed adjacent to the outlet port 106d. The spring 114 is mounted in the outlet port 106d. The ball 112 is movable in the valve chamber 106f to open and close the outlet port 106d. The retainer plate 113 is formed with a number of slits through which gas passes. This check valve 104 is configured to close to inhibit the back-flow of high pressure gas when flows back from the intake passage 21 into the hollow part 108c of the third housing 108 through the returning passage 32. Closing this check valve 104 can prevent the back-flow of high pressure gas from the PCV valve 150 to the crank chamber 7 of the engine.

The step motor 103 includes the motor case 111 and besides a stator 115 which generates electromagnetic force and a rotor 117 centrally placed in the stator 115 and integrally provided with an output shaft 116. At a leading end portion of the output shaft 116, the valve element 102 is arranged. Specifically, the output shaft 116 and the valve element 102 are coupled to each other by threadedly engaging an external tread 116a formed on an outer periphery of the output shaft 116 in a threaded hole 102a formed in the valve element 102. By rotation of the output shaft 116, accordingly, the valve element 102 is axially moved by the relation of the external thread 116a and the threaded hole 102a. The moving direction of the valve element 102 depends on the rotation direction (normal rotation and reverse rotation) of the output shaft 116. Leading ends of the external terminals 118 extending from the stator 115 protrude in the connector part 107a.

The valve element 102 is designed to have a truncated-cone-shaped distal end portion. The valve seat 101 has a valve hole 101a centrally formed. The distal end portion of the valve element 102 is placed to pass through the vent hole 101a of the valve seat 101. In this embodiment, the output shaft 116 of the step motor 103 and the valve element 102 are made of metal such as aluminum. The step motor 103 and the valve element 102 are thus thermally connected with the metallic output shaft 116 having higher thermal conductivity than the resin housing 105. Accordingly, heat generated in the step motor 103 will be conducted to the valve element 102 through the output shaft 106.

In this embodiment, a cover 119 is provided to enclose the valve element 102 in the valve chamber 110. This cover 119 has a nearly cylindrical shape formed with a hole 119a at a distal end and a flange 119b at a proximal end. The valve element 102 is placed extending through the hole 119a. The cover 119 is formed of metal such as aluminum having higher thermal conductivity than the housing 105. The cover 119 is placed so that the flange 119b is held in contact with an end face of the motor 111 of the step motor 103. The flange 119b of the cover 119 is fixed to the end face of the motor case 111 by caulking. Thus, the cover 119 and the motor case 111 are made integral. The valve element 102 is formed with a flange 102b at a proximal end. In the cover 119, a compression spring 120 is mounted between the inner wall of the distal end of the cover 119 and the flange 102b of the valve element 102. The valve element 102 is urged by this spring 120 in a direction away from the valve seat 101. In this embodiment, the cover 119 is made of a material having higher thermal conductivity than the housing 105 and is placed to be exposed in the valve chamber 110 constituting the blow-by gas passage. The flange 119b of the cover 119 is held in contact with the motor case 111 and hence the cover 119 and the motor case 111 are thermally connected with each other.

In this embodiment, an assembly including the valve element 102, the step motor 103, the second housing 107, the cover 119, and the spring 120 is assembled with the first housing 106 by press-fitting the cover 119 in the hollow part 106a of the first housing 106 and joining joint surfaces of the first and second housings 106 and 107 by ultrasonic welding.

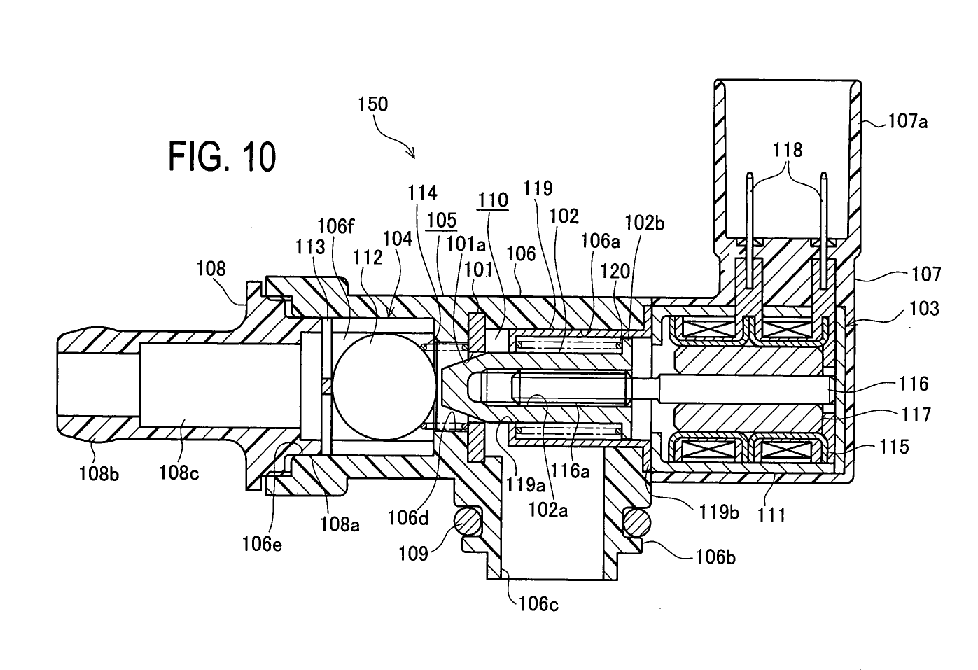

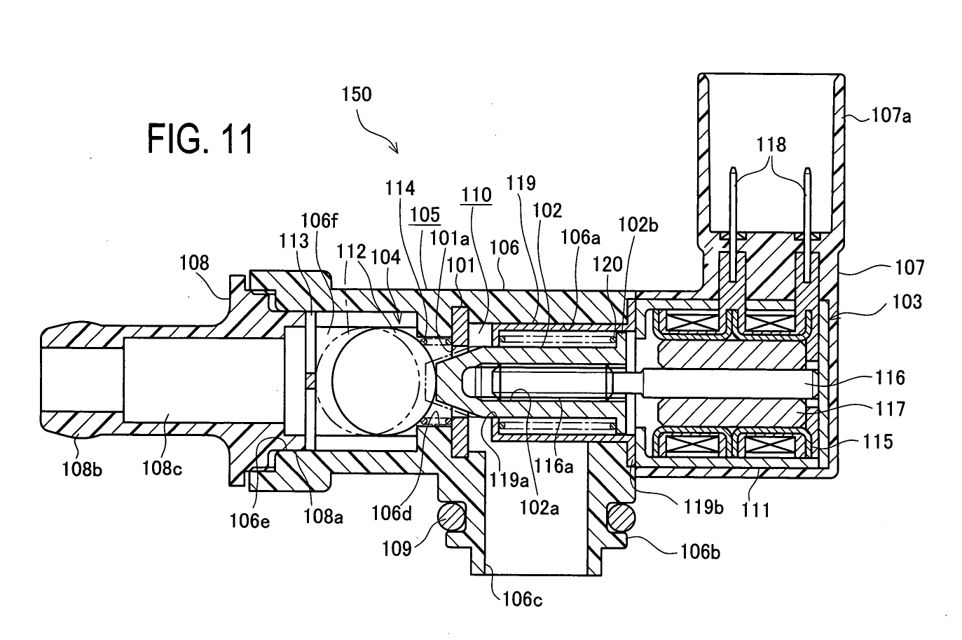

Herein, the positional relation between the valve element 102 of the PCV valve 150 and the ball 112 of the check valve 104 is explained below. FIG. 9 is a view showing a state where the ball 112 of the check valve 104 is in a valve opening position apart from the outlet port 106d and the valve element 102 of the PCV valve 150 is in a valve opening position apart from the valve seat 101. In this state, the ball 112 of the check valve 104 and the valve element 102 of the PCV valve 150 are apart from each other. This state where the ball 112 is apart from the outlet port 106d represents a normal initial state in which the ball 112 is being pressed by the spring 114 for valve opening. When high pressure gas flows back in the hollow part 108c of the third housing 108, the ball 112 is pressed by the high pressure gas against the urging force of the spring 114 to close the outlet port 106d, so that the check valve 104 is changed from the above initial state to the valve closing state. Because of this valve closing state, the check valve 104 can prevent the back-flow of high pressure gas from the PCV valve 150 to the crank chamber 7. On the other hand, even when the valve element 102 of the PCV valve 150 is moved from the position in FIG. 9 into contact with the valve seat 101 as shown in FIG. 10, the valve element 102 does not bump the ball 112. Thus, the valve element 102 can normally operate. In this embodiment, the ball 112 and the valve element 102 are disposed in such positions that, while the check valve 104 is closed in which the ball 112 is held in contact with the outlet port 106d as indicated by a solid line in FIG. 11, the valve element 102 bump the ball 112 when the valve element 102 is moved into contact with the valve seat 101 for valve closing. This configuration that the valve element 102 is able to bump the ball 112 in the valve closing state is to prevent the ball 112 in the valve closing state from sticking to or biting the outer edge of the outlet port 106d, which disturbs normal operation.

Accordingly, the blow-by gas returning apparatus in this embodiment can provide basically the same operations and advantages as in the first embodiment. In addition, according to the PCV valve 150 in this embodiment, while the ball 112 of the check valve 104 is in the valve closing state as indicated by the solid line in FIG. 11, even in case the ball 12 sticks to or bites the outer edge of the outlet port 106d, the valve element 102 of the PCV valve 150 bumps the ball 112 when the valve element 102 is moved to the valve closing position, thereby forcibly releasing the stuck state of the ball 112 as indicated by a double-dashed line in FIG. 11. This results in preventing malfunction of the check valve 104 due to sticking or the like. Accordingly, it is possible to prevent the closing of the PCV valve 150 caused by malfunction of the check valve 104 and avoid interruption of the flow of blow-by gas to the returning passage 32. This makes it possible to prevent blow-by gas in the crank chamber 7 from flowing back in the intake passage 21 through the vent holes 35 and the scavenging passage 34, to avoid accumulation of deposits in the intake passage 21, or to prevent deterioration of engine oil.

Herein, under a normal use condition of the PCV valve 150, the valve element 102 will not bump the ball 112 of the check valve 104. In this embodiment, in case the sticking or other malfunction of the check valve 104 occurs, the valve element 102 of the PCV valve 150 is caused to move to the valve closing position every start-up of the engine 1 to forcibly release such malfunction.

The present invention is not limited to the above embodiment(s) and may be embodied in other specific forms without departing from the essential characteristics thereof.

In the first to third embodiments, the check valve 55 is provided integral with each of the PCV valves 33, 61, and 62. Alternatively, the check valve may be provided separately from the PCV valve. For instance, the check valve may be provided somewhere in a pipe constituting the returning passage.

The first and second embodiments embody the blow-by gas returning apparatus of the invention in the engine 1 with the supercharger 27. The blow-by gas returning apparatus of the invention may also be applied to an engine with no supercharger.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. An engine blow-by gas returning apparatus comprising:
a returning passage through which blow-by gas which leaks from a combustion chamber of an engine into a crank case is allowed to flow in an intake passage to return to the combustion chamber; and
a PCV valve placed in the returning passage to regulate a flow rate of the blow-by gas,
wherein the PCV valve is adapted to change a position of a valve element by electromagnetic force to change a passage opening area, and
the apparatus further includes an inhibition valve for inhibiting back-flow of gas from the intake passage, the inhibition valve being placed in the returning passage upstream of the valve element of the PCV valve.

2. An engine blow-by gas returning apparatus comprising:
a returning passage through which blow-by gas which leaks from a combustion chamber of an engine into a crank case is allowed to flow in an intake passage to return to the combustion chamber; and
a PCV valve placed in the returning passage to regulate a flow rate of the blow-by gas,
wherein the PCV valve is adapted to change a position of a valve element by electromagnetic force to change a passage opening area, and
the apparatus further includes an inhibition valve for inhibiting back-flow of gas from the intake passage, the inhibition valve being placed in the returning passage downstream of the valve element of the PCV valve.

3. The engine blow-by gas returning apparatus according to claim 2, wherein
the inhibition valve and the valve element are disposed in such positions that they will bump each other when the valve element is closed while the inhibition valve is in a closed state.

4. The engine blow-by gas returning apparatus according to claim 1, further comprising:
a supercharger placed in the intake passage upstream of an entrance of the returning passage and arranged to pressurize pressure of intake air in the intake passage;
a second returning passage having one end communicating with the returning passage upstream of the inhibition valve and the other end communicating with the intake passage upstream of the supercharger, and
a second PCV valve placed in the second returning passage and adapted to change a position of the valve element by pressure to change the passage opening area.

5. The engine blow-by gas returning apparatus according to claim 2, further comprising:
a supercharger placed in the intake passage upstream of an entrance of the returning passage and arranged to pressurize pressure of intake air in the intake passage;
a second returning passage having one end communicating with the returning passage upstream of the inhibition valve and the other end communicating with the intake passage upstream of the supercharger, and
a second PCV valve placed in the second returning passage and adapted to change a position of the valve element by pressure to change the passage opening area.

6. The engine blow-by gas returning apparatus according to claim 3, further comprising:
a supercharger placed in the intake passage upstream of an entrance of the returning passage and arranged to pressurize pressure of intake air in the intake passage;
a second returning passage having one end communicating with the returning passage upstream of the inhibition valve and the other end communicating with the intake passage upstream of the supercharger, and
a second PCV valve placed in the second returning passage and adapted to change a position of the valve element by pressure to change the passage opening area.

7. The engine blow-by gas returning apparatus according to claim 4, further comprising a scavenging passage through which fresh air is allowed to be introduced in the crank case, the scavenging passage having an entrance communicating with the intake passage downstream of the supercharger.

8. The engine blow-by gas returning apparatus according to claim 5, further comprising a scavenging passage through which fresh air is allowed to be introduced in the crank case, the scavenging passage having an entrance communicating with the intake passage downstream of the supercharger.

9. The engine blow-by gas returning apparatus according to claim 6, further comprising a scavenging passage through which fresh air is allowed to be introduced in the crank case, the scavenging passage having an entrance communicating with the intake passage downstream of the supercharger.

10. The engine blow-by gas returning apparatus according to claim 4, wherein
the second PCV valve is operated to increase the passage opening area as a difference in pressure between an upstream side and a downstream side of the second PCV valve is larger.

11. The engine blow-by gas returning apparatus according to claim 5, wherein
the second PCV valve is operated to increase the passage opening area as a difference in pressure between an upstream side and a downstream side of the second PCV valve is larger.

12. The engine blow-by gas returning apparatus according to claim 6, wherein
the second PCV valve is operated to increase the passage opening area as a difference in pressure between an upstream side and a downstream side of the second PCV valve is larger.

13. The engine blow-by gas returning apparatus according to claim 7, wherein
the second PCV valve is operated to increase the passage opening area as a difference in pressure between an upstream side and a downstream side of the second PCV valve is larger.

14. The engine blow-by gas returning apparatus according to claim 8, wherein
the second PCV valve is operated to increase the passage opening area as a difference in pressure between an upstream side and a downstream side of the second PCV valve is larger.

15. The engine blow-by gas returning apparatus according to claim 9, wherein
the second PCV valve is operated to increase the passage opening area as a difference in pressure between an upstream side and a downstream side of the second PCV valve is larger.

16. An engine blow-by gas returning apparatus comprising:
a returning passage through which blow-by gas which leaks from a combustion chamber of an engine into a crank case is allowed to flow in an intake passage, in which a supercharger is placed, to return to the combustion chamber; and
a PCV valve placed in the returning passage to regulate a flow rate of the blow-by gas,
wherein
the PCV valve is adapted to change a position of a PCV valve element by pressure to change a passage opening area,
the returning passage has one end communicatable with inside of the crank case and the other end communicating with the intake passage downstream of the supercharger,
the apparatus further comprises
an inhibition valve placed in the returning passage and adapted to inhibit a flow of gas from the intake passage,
a second returning passage having one end communicating with the returning passage upstream of the inhibition valve and the other end communicatable with the intake passage upstream of the supercharger, and
a second PCV valve placed in the second returning passage and adapted to change a position of the valve element by pressure to change a passage opening area,
the second PCV valve is operated to increase the passage opening area as a difference in pressure between an upstream side and a downstream side of the second PCV valve is larger.

17. The engine blow-by gas returning apparatus according to claim 16, wherein
the PCV valve serves as the inhibition valve for inhibiting a flow of gas from the intake passage.

18. The engine blow-by gas returning apparatus according to claim 16, further comprising a scavenging passage through which fresh air is allowed to be introduced into the crank case, the scavenging passage having an entrance communicating with the intake passage downstream of the supercharger.

19. The engine blow-by gas returning apparatus according to claim 17, further comprising a scavenging passage through which fresh air is allowed to be introduced into the crank case, the scavenging passage having an entrance communicating with the intake passage downstream of the supercharger.
